(19) United States
(12) Patent Application Publication
(10) Pub. No.: US 2018/0050675 A1
(43) Pub. Date: Feb. 22, 2018

(54) APPARATUS FOR REDUCING A SPEED OF A MOTOR VEHICLE

(71) Applicant: FORD GLOBAL TECHNOLOGIES, LLC, Dearborn, MI (US)

(72) Inventors: Frederic STEFAN, Aachen NRW (DE); Uwe GUSSEN, Huertgenwald NRW (DE); Christoph ARNDT, Moerlen Rheinland-Pfalz (DE)

(73) Assignee: FORD GLOBAL TECHNOLOGIES, LLC, Dearborn, MI (US)

(21) Appl. No.: 15/677,558

(22) Filed: Aug. 15, 2017

(30) Foreign Application Priority Data
Aug. 17, 2016 (DE) 102016215397.8

(51) Int. Cl. B60T 8/72; B60T 8/32; B60W 10/10; B60W 40/105; B60W 50/14; G01C 21/26; G06K 9/00

(52) U.S. Cl. CPC B60T 8/72; B60T 8/3205; B60T 8/3295; B60W 10/10; B60W 2050/0089; B60W 50/14; G01C 21/26; G06K 9/00791; B60T 2250/04; B60W 40/105

(57) ABSTRACT

The disclosure relates to an apparatus configured to reduce a speed of a motor vehicle to a predetermined value at a predetermined position. The apparatus includes a position-capture device configured to establish the predetermined position by evaluating map data relating to a planned route of the motor vehicle, and a target-setting device for establishing the predetermined value at the predetermined position.

### CROSS-REFERENCE TO RELATED APPLICATIONS

This application claims foreign priority benefits under 35 U.S.C. §119(a)-(d) to DE Application 10 2016 215 397.8 filed Aug. 17, 2016, which is hereby incorporated by reference in its entirety.

### TECHNICAL FIELD

The disclosure relates to an apparatus for reducing a speed of a motor vehicle.

### BACKGROUND

In the course of operating a motor vehicle, many traffic situations may arise that require the motor vehicle to be decelerated to a very low speed or even to a complete standstill. This may be the case, for example, when the motor vehicle is approaching a traffic signal, an intersection or a crosswalk. The position of a traffic signal, an intersection or a crosswalk may be visually recognizable for a motor-vehicle driver, but cannot be captured by a spacing radar or lidar system from a defined distance.

Consequently, speed-regulating systems—such as, for example, adaptive cruise control (ACC)—that draw upon sensor data pertaining to such a spacing radar or lidar system cannot be used in order to regulate a speed in such a manner that the speed has a defined value at a defined position, since they operate reliably only up to distances of about 200 meters.

It is therefore an object of the disclosure to demonstrate ways in which the speed of a motor vehicle at a defined position can be brought to a defined value.

### SUMMARY

The object of the disclosure is achieved by an apparatus that reduces a speed of a motor vehicle to a predetermined value at a predetermined position. The apparatus includes a position-capture device that establishes the predetermined position by evaluating map data relating to a planned route of the motor vehicle, and a target-setting device that establishes the predetermined value at the predetermined position.

The predetermined position may be, for example, a traffic signal, a crosswalk, an intersection, a stop sign or other traffic sign, or a curve that can be passed only at reduced speed or requires a complete stoppage of the motor vehicle. Furthermore, the passing of the predetermined position may require that a lower gear having a lower gear ratio be chosen, by changing down.

The position-capture device draws upon map data and—by comparison with a planned route that, for example, was ascertained by a navigation instrument—ascertains positions at which a traffic signal, a crosswalk, an intersection, a stop sign or other traffic sign are located, or at which a curve is located. These positions may have been specially marked in the map data. The map data may have been archived in the navigation instrument, or it may be a question of a global positioning system (GPS) map. Furthermore, the map data can be retrieved from the position-capture device via a vehicle-to-base-station communication (car to infrastructure, C2I). In other words, the position-capture device serves as a far-field sensor that captures relevant objects that are further away from the motor vehicle than the maximum range of near-field sensors of the motor vehicle, such as, for example, a spacing radar or lidar system.

The target-setting device then determines the value of the speed that is to be attained at the predetermined position. Here, the target-setting device additionally evaluates the location of the predetermined position (for example, at the end of an incline), other features, the distance up until the predetermined position, and also the current speed. For example, within a locality with traffic-calmed sections, it may be necessary to decelerate the motor vehicle to a speed of, for example, 20 km/h to 30 km/h in second gear, in order to bring the motor vehicle to a standstill sufficiently and quickly if need be, for example on account of children playing on a play street.

With the apparatus, a motor vehicle can be brought to a standstill, or to a lower speed if the vehicle is approaching a traffic signal, a stop sign, or if another traffic sign requires a reduction of the speed and then operation in second gear. The operating range of this apparatus is greater than in the case of known speed-regulating systems with a spacing radar or lidar system. Furthermore, this apparatus fills a gap in the development toward autonomous driving.

According to an embodiment, the disclosure provides that the target-setting device is designed to make available a speed profile to attain the predetermined value. Accordingly, not only is the final value of the speed established that the motor vehicle is to have when it reaches the predetermined position, but a progression regarding the manner in which the speed is to decrease is predetermined. In this way, a particularly uniform and jerk-free decelerating of the motor vehicle can be obtained.

According to a further embodiment, the disclosure provides that an identifying and classifying device is designed to evaluate raw map data, in order to determine the predetermined positions for the map data. The predetermined positions can then be entered into map data representing road maps, and can be provided with features that characterize them, such as, for example, number of side-streets, right-of-way regulations, traffic signs, number of lanes, and presence of traffic signals. The map data may have been archived in a navigation instrument of the motor vehicle or in a cloud to which the apparatus has access via a wireless data link, for example via a vehicle-to-base-station communication (car to infrastructure, C2I).

According to a further embodiment, the disclosure provides that a speed-regulating device is provided, which makes available a correcting variable to attain the predetermined value at the predetermined position. For this purpose, the speed-regulating device can evaluate internal and external parameters. The speed is monitored and updated continuously, in order to attain the value of the speed in real-time, or to adhere to the speed profile. Internal parameters may be the current speed, the current position of the motor vehicle in relation to the predetermined position, as well as other presets such as a quality criterion, in order to guarantee a particularly jerk-free adaptation of the speed. External parameters may be the general traffic situation, the presence of a road user ahead of, or behind the motor vehicle, weather conditions, speed limits or other local basic conditions.

According to a further embodiment, the disclosure provides that a control unit sets a motor-vehicle speed at least on the basis of the correcting variable. The control unit may be a control unit of a cruise control system, or of a spacing regulator, and can accelerate, actuate the brake and control the gear selection in order to attain a desired motor-vehicle speed.

According to a further embodiment, the disclosure provides that the apparatus is configured to be deactivated by another device, in particular an emergency-braking assistant. The apparatus, particularly if it has a control unit of a cruise control system, or of a spacing regulator, can overwrite or ignore the correcting variable if an obstacle ahead of the motor vehicle was captured, so that, for example, an emergency stop is necessary.

According to a further embodiment, the apparatus is designed to read in at least one value of a speed preset from another device, in particular an emergency-braking assistant, of the motor vehicle, to compare the value with the value of the speed at the predetermined position, and to select one of the values in accordance with a criterion. A criterion may be the magnitude of the values, and the lowest value in the given case is selected. In this connection, the selected value is indicative of an obstacle in the travel path of the motor vehicle that necessitates an emergency stop. But other algorithms—such as, for example, learning algorithms—may also be used in order to select one of the values. The algorithms may further include an evaluation of vehicle-dynamics data, of recorded or historical data, or of linked data.

According to a further embodiment, the disclosure provides that the apparatus is designed to read in and to evaluate sensor data from a motor-vehicle sensor for capturing obstacles along the route. In contrast to the far-field sensors mentioned in the introduction, the motor-vehicle sensor—such as, for example, the spacing radar, the lidar system or camera systems—constitutes a near-field sensor by reason of its limited range of, for example, 200 meters. Consequently, given sufficient approach to the predetermined position, an activation takes place of the near-field sensors, the data being utilized in order to bring about a reduction of the speed to a predetermined value at a predetermined position, or in order to increase the accuracy through their additional use.

The disclosure will now be elucidated on the basis of a drawing.

### BRIEF DESCRIPTION OF THE DRAWINGS

FIG. 1 depicts a scenario that, starting from a predetermined position, a motor vehicle travels at a predetermined speed;

FIG. 2 depicts a schematic representation of components of the motor vehicle represented in FIG. 1; and

FIG. 3 depicts a schematic representation of components of the apparatus represented in FIG. 2 for reducing a speed of a motor vehicle.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

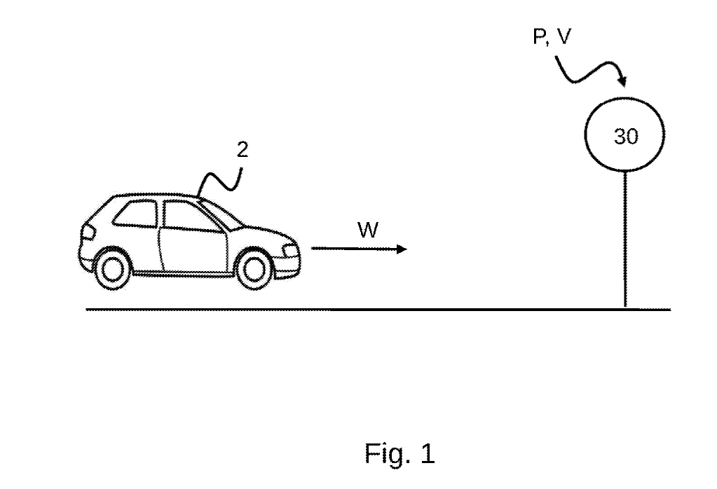

Reference will firstly be made to FIG. 1.

Represented is a scenario in which a motor vehicle 2, for example an automobile, is moving along a planned route W. The planned route W was ascertained in the present exemplary embodiment by a navigation instrument (not represented) of the motor vehicle 2 after a motor-vehicle driver entered a destination address.

In the scenario represented in FIG. 1, the motor vehicle 2 is moving along the planned route W toward a zone 30 but still exhibits a spacing of more than 200 meters from a traffic sign 20 defining a beginning of the zone 30.

Consequently, in the present exemplary embodiment, the traffic sign 20 defines a predetermined position P that can be passed only at a reduced speed—that is to say, at a predetermined value V of a speed, which in the present exemplary embodiment is 30 km/h—and subsequently defines a maximally permissible maximum speed of the motor vehicle 2.

Diverging from the present exemplary embodiment, the predetermined position P may also be a traffic signal, an intersection, a crosswalk or a curve that can be passed only at reduced speed or that require a complete stoppage of the motor vehicle 2.

By reason of the spacing of more than 200 meters, which in the present scenario, systems such as camera systems for traffic-sign capture (or other systems such as a spacing radar or lidar system for capturing a traffic signal, an intersection, a crosswalk or a curve) cannot be used to capture the predetermined position P.

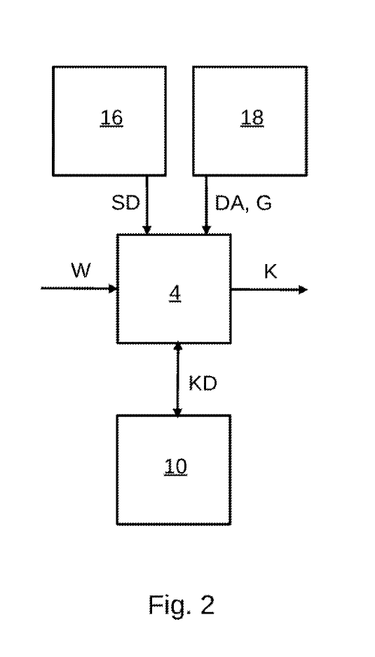

Reference will now additionally be made to FIG. 2, which shows, in schematic representation, an apparatus 4 that reduces a speed of the motor vehicle 2 to a predetermined value V at a predetermined position P, and also further components of the motor vehicle 2 that have been connected to the apparatus 4 directly or indirectly in data-transmitting manner, for example via a CAN bus.

In the case of the further components in the present exemplary embodiment, the further components are a motor-vehicle sensor 16 such as, for example, a camera system, a spacing radar and/or lidar system with a maximum range of, for example, 200 meters. In other words, the motor-vehicle sensor 16 is a near-field sensor. The sensor data SD captured with the motor-vehicle sensor 16 are transmitted to the apparatus 4 and evaluated therein, as will be elucidated later in detailed manner.

Furthermore, the apparatus 4 has been connected to another device 18 in such a manner that this other device 18 can deactivate the apparatus 4. In the case of the other device 18, the other device 18 may be, for example, an emergency-braking assistant of the motor vehicle 2. By an “emergency-braking assistant”, a driver-assistance system for motor vehicles 2 is understood, which, in the event of danger, assists or automatically initiates an emergency stop as a preventive measure. In addition, further safety measures may be taken. By this means, the collision with an obstacle may be avoided, or at least the energy introduced may be reduced as far as possible by braking beforehand. In this way, the emergency-braking assistant can additionally, or alternatively, generate a collision warning and/or initiate an autonomous emergency stop.

Moreover, the apparatus 4 is designed to read in the planned route W and map data KD, the map data KD being made available by an identifying and classifying device 10.

The predetermined position P has been marked in the map data KD. The map data KD may, for example, have been archived in the navigation instrument, or it may be a question of a GPS map. Furthermore, the map data KD can be retrieved from the apparatus 4 via a vehicle-to-base-station communication (car to infrastructure, C2I), in which case the map data KD have then been stored in a cloud. Furthermore, in the present exemplary embodiment, the fact that a zone 30 begins at the predetermined position P has been assigned to the predetermined position P as a feature.

The map data KD were generated by the identifying and classifying device 10. The identifying and classifying device 10 may have been assigned to the motor vehicle 2, or in the case of the identifying and classifying device 10, the identifying and classifying device 10 may be a cloud service, which evaluates raw map data to determine the predetermined positions P for the map data KD.

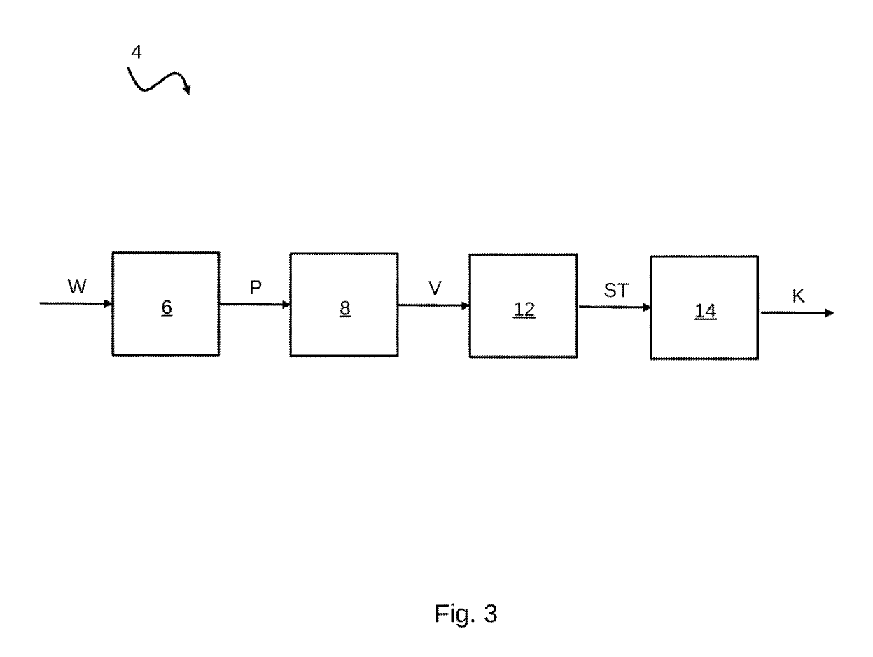

Reference will now additionally be made to FIG. 3.

Components of the apparatus 4 are represented. In the case of the components of the apparatus 4 in the present exemplary embodiment, the components of the apparatus may include a position-capture device 6, a target-setting device 8, a speed-regulating device 12 and a control unit 14. The position-capture device 6, the target-setting device 8, the speed-regulating device 12 and the control unit 14 may exhibit hardware components and/or software components for the task described in the following.

The position-capture device 6 also reads in the map data KD in addition to the planned route W. The predetermined position P is ascertained by a comparison of the planned route W with the map data KD. The position-capture device 6 transmits the predetermined position P to the target-setting device 8. In other words, the position-capture device 6 serves as far-field sensor that captures relevant objects that are further away from the motor vehicle 2 than the maximum range of near-field sensors of the motor vehicle 2.

The target-setting device 8 determines the value V of a speed that is to be attained at the predetermined position P, by evaluating the feature in the map data KD that is assigned to the predetermined position P. In addition, the target-setting device 8 may have been designed to take further information into consideration, such as, for example, the location of the predetermined position P, for example, at the end of an incline, the distance up until the predetermined position P, and also a current speed. In addition, the target-setting device 8 can also determine a gear preset that is brought to the attention of a motor-vehicle driver visually and/or acoustically if the motor vehicle 2 has a manual transmission to be actuated manually. If, on the other hand, the motor vehicle 2 has an automatic transmission, the target-setting device 8 generates a corresponding gear-shift signal.

Moreover, the target-setting device 8 may have been designed to make available a speed profile that attains the predetermined value. Accordingly, not only is a final value of the value V of the speed established that the motor vehicle 2 is to have at the predetermined position P, but a progression regarding the manner in which the speed is to decrease is predetermined. In this way, a particularly uniform and jerk-free decelerating of the motor vehicle 2 can be obtained.

The speed-regulating device 12 makes available at least one correcting variable ST that attains the predetermined value V at the predetermined position P. In this way, the speed-regulating device 12 continuously monitors the speed, and updates the speed, in order to adhere to the value W upon reaching the predetermined position P, or to adhere to the speed profile. For this purpose, the speed-regulating device 12 can evaluate internal and external parameters. Internal parameters may be the current speed, the current position of the motor vehicle 2 in relation to the predetermined position, as well as other presets such as a quality criterion, in order to guarantee a particularly jerk-free adaptation of the speed. External parameters may be the general traffic situation, the presence of a road user ahead of or behind the motor vehicle 2, weather conditions, speed limits or other local basic conditions.

The control unit 14 reads in the correcting variable ST and sets the motor-vehicle speed K on the basis of at least the correcting variable ST. The control unit 14 may be a control unit of a cruise control system, a spacing regulator or adaptive cruise control system, and can accelerate, actuate the brake and, where appropriate, control the gear selection, in order to obtain the desired value V of speed. In this way, by a “cruise control system”—also called an electronic speed-control system (ESC)—an apparatus in the motor vehicle 2 is understood that regulates the rotational speed of an engine of the motor vehicle 2 automatically in such a way that the motor vehicle 2 adheres, as far as possible, to a speed that is predetermined by the motor-vehicle driver. By a “spacing regulator” or “adaptive cruise control” (ACC), on the other hand, a speed-regulating system is understood that in the course of regulation additionally incorporates a spacing from a motor vehicle traveling ahead as an additional feedback variable and correcting variable. In this way, a spacing regulator or adaptive cruise control of such a type draws upon the sensor data SD of the motor-vehicle sensor 16—for example, a spacing radar—which are also utilized by an emergency-braking assistant.

In operation, the planned route W and the map data KD are read in by the position-capture device 6. The predetermined position P is ascertained by a comparison of the planned route W with the map data KD.

The target-setting device 8 determines at least the value V of the speed that is to be attained at the predetermined position P by evaluating the feature in the map data KD that is assigned to the predetermined position P.

The speed-regulating device 12 makes available at least one correcting variable ST that attains the predetermined value V at the predetermined position P, and subsequently, continuously monitors the speed and updates the speed, in order to attain the value W upon reaching the predetermined position P.

The control unit 14 reads in the correcting variable ST and sets the motor-vehicle speed K on the basis of at least the correcting variable ST.

If, during the approach to the predetermined position P—that is to say, with an active apparatus 4—the further device 18—for example, an emergency-braking assistant—captures an obstacle ahead of the motor vehicle 2 along the planned route W, the further device 18 deactivates the apparatus 4 by a deactivation signal DA, so that only the further device 18 regulates the motor-vehicle speed K, or can initiate an emergency stop.

Alternatively, the disclosure may provide that the apparatus 4 is designed to read in a value of a speed preset G, for example from the further device 18 or from other devices. Further, the apparatus 4 compares at least the value V of the speed at the predetermined position P, or a speed value according to a speed profile, and also the value of a speed preset G from the further device 18, and selects—in accordance with a criterion, for example the magnitude of the values—the lowest value, which serves as preset for the motor-vehicle speed K.

If the motor vehicle 2 has approached the predetermined position P so far that, in the present exemplary embodiment, the spacing amounts to less than 200 meters, an activation of the motor-vehicle sensor 16 takes place. Consequently, after sufficient approach to the predetermined position P, the sensor data SD of the motor-vehicle sensor 16, serving as near-field sensors, are utilized in order to bring about the reduction of the speed to the predetermined value V at a predetermined position P, or in order to increase the accuracy through additional use of the sensors.

With the apparatus 4, a motor vehicle 2 can be brought to a standstill, or to a low speed, if it is approaching a traffic signal, a stop sign or another traffic sign at a predetermined position P that requires a reduction of the speed to a predetermined value V and also, where appropriate, operation in second gear. The operating range of this apparatus 4 is greater than in known speed-regulating systems with a spacing radar or lidar system. Furthermore, this apparatus 4 fills a gap in the development toward autonomous driving.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A vehicle speed reducing apparatus comprising:
a position-capture device configured to establish a predetermined position based on map data related to a planned route, and
a target-setting device configured to establish a predetermined value at the predetermined position.

2. The vehicle speed-reducing apparatus as claimed in claim 1, wherein the target-setting device is further configured to generate a speed profile to attain the predetermined value.

3. The vehicle speed-reducing apparatus as claimed in claim 1 further comprising an identifying-and-classifying device configured to evaluate raw map data to determine the predetermined position from the map data.

4. The vehicle speed-reducing apparatus as claimed in claim 1 further comprising a speed-regulating device configured to generate a correcting variable to attain the predetermined value at the predetermined position.

5. The vehicle speed-reducing apparatus as claimed in claim 4 further comprising a control unit configured to set a vehicle speed at least based on the correcting variable.

6. The vehicle speed-reducing apparatus as claimed in claim 1 further comprising an emergency-braking assistant configured to deactivate the position-capture and image-setting devices.

7. The vehicle speed-reducing apparatus as claimed in claim 6, wherein the emergency-braking assistant is further configured to provide a speed preset to the target-setting device.

8. The vehicle speed-reducing apparatus as claimed in claim 7, wherein the target-setting device is further configured to compare the speed preset with the predetermined value at the predetermined position, and select one of the speed preset or predetermined value in accordance with a criterion.

9. The vehicle speed-reducing apparatus as claimed in claim 1, wherein the position-capture is further configured to evaluate sensor data-a vehicle sensor configured to image obstacles along the route.

10. A vehicle comprising:
a speed control unit configured to, in response to input indicative of a predetermined position based on an evaluation of raw map data from an identifying and classifying device, map data related to a planned route, and sensor data indicative of obstacles along the planned route, establish a predetermined value, attained via a speed profile and correcting variable generated by a speed-regulating device, at the predetermined position.

11. The vehicle as claimed in claim 10, wherein the speed control unit is further configured to set a speed based on the correcting variable.

12. The vehicle as claimed in claim 10 further comprising a braking assistant configured to deactivate the speed control unit.

13. The vehicle as claimed in claim 12, wherein the emergency-braking assistant is further configured to provide a speed preset to the speed control unit.

14. The vehicle as claimed in claim 13, wherein the speed control unit is further configured to compare the speed preset with the predetermined value at the predetermined position, and select one of the speed preset or predetermined value in accordance with a criterion.

15. A vehicle speed control system comprising:
a position-capture device configured to establish a predetermined position based on an evaluation of raw map data from an identifying and classifying device, map data related to a planned route, and sensor data indicative of obstacles along the planned route; and
a target-setting device configured to establish a predetermined value, attained via a speed profile and correcting variable generated by a speed-regulating device, at the predetermined position.

16. The vehicle speed control system as claimed in claim 15 further comprising an emergency-braking assistant configured to deactivate the position-capture and image-setting devices.

17. The vehicle speed control system as claimed in claim 16, wherein the emergency-braking assistant is further configured to provide a speed preset to the target-setting device.

18. The vehicle speed control system as claimed in claim 17, wherein the target-setting device is further configured to compare the speed preset with the predetermined value at the predetermined position, and select one of the speed preset or predetermined value in accordance with a criterion.
